(19) United States
(12) Patent Application Publication
(10) Pub. No.: US 2010/0067553 A1
(43) Pub. Date: Mar. 18, 2010

(54) SYNCHRONIZATION OF VIDEO WITH TELEMETRY SIGNALS METHOD AND APPARATUS

(75) Inventors: Michael McKINNEY, Madison, WI (US); James S. Hein, Madison, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: VIASYS HEALTHCARE, INC, Conshohoken, PA (US)

(21) Appl. No.: 12/433,922

(22) Filed: May 1, 2009

Related U.S. Application Data
(60) Provisional application No. 61/096,656, filed on Sep. 12, 2008.

(51) Int. Cl. H04J 3/06

(52) U.S. Cl. 370/503; 348/500

(57) ABSTRACT

An Ethernet-compatible synchronization process between isolated digital data streams assures synchronization by embedding an available time code from a first stream into data locations in a second stream that are known a priori to be unneeded. Successive bits of time code values, generated as a step in acquiring and digitizing analog sensor data, are inserted into least-significant-bit locations in a digitized audio stream generated along with digitized image data by a digital video process. The overwritten LSB locations are shown to have no discernable effect on audio reconstructed from the Ethernet packets. Telemetry recovery is the reverse of the embedment process, and the data streams are readily synchronized by numerical methods.

This application is related to U.S. Provisional Patent Application Ser. No. 61/096,656, titled “Synchronization of Video With Telemetry Signals Method and Apparatus,” filed Sep. 12, 2008, the disclosures of each which are hereby incorporated by reference in their entirety.

### FIELD OF THE INVENTION

The present invention relates generally to acquisition, storage, transfer, and display of medical data in electronic form. More particularly, the present invention relates to a method and apparatus for synchronizing signals between a digitized and Ethernet-transmitted television signal stream (video and audio) and a digitized and Ethernet-transmitted medical measurement telemetry stream.

### BACKGROUND OF THE INVENTION

In certain medical and research environments, such as hospitals, clinics, laboratories, doctors' offices, and similar locations, significant numbers of patients (potentially termed clients or subjects in some environments, and potentially nonhuman or inorganic in other environments) may be monitored simultaneously by test apparatus. Where such monitoring is prolonged, such as in intensive care wards, sleep clinics, research laboratories, and other environments, high-performance, and thus costly and relatively scarce, apparatus may be in significant demand, while data furnished by such apparatus may require nurse, clinician, or other user attention with high update frequency, capability to access extended amounts of archival data, or other potentially high bandwidth needs. As automation has advanced, centralized locations, such as nurses' stations, have increased in technical complexity, with monitoring, display, and storage devices placed remotely from points of data acquisition, both to reduce staffing needs and to control the test environment, particularly during overnight monitoring periods.

Known technologies, specifically for applications requiring video image transfer and monitoring of vital signs, have migrated at least in part from all-analog functionality toward all-digital equivalence. While potentially offering data management advantages as digital information storage costs have declined, digitization neither intrinsically improves data throughput, nor assures technical integration of telemetry with imaging. Synchronization of video/audio signal streams and physiological and other measurement data streams is a shortcoming of present practice.

There exist numerous other technical limitations of current practice. Some of these are related to analog-to-digital conversion and related signal processing needs, specifically including filtering methods for low-amplitude, low-frequency signals. Others are related to communication handshaking for establishing and maintaining data flow between elements of a network-based multi-element monitoring system.

Accordingly, there is a need in the physiological sensor art for improved methods for establishing linkage between networked sensing, display, and recording elements, for digital data and streaming video/audio synchronization, and for signal processing techniques in advance of those in current use.

### SUMMARY OF THE INVENTION

Preferred embodiments of the invention provide a data acquisition and management system that combines multiple channels of sensor data acquisition, digitization, and resolution management with camera-based image and sound acquisition, digitization, selective frame rate control and pixel decimation, followed by message construction and transmission. A system may further include Ethernet interface, multi-subject and multi-viewer information flow control, and individualized display presentation and formatting. A system may further include digital filtering with reduced filter-generated noise artifacts. Embodiments of the invention provide sensor data stream synchronization time stamps embedded within digitized video/audio data streams, so that the two distinct streams of a patient monitor can be unambiguously resynchronized at any time.

In a first aspect, an Ethernet-compatible apparatus for synchronization of first and second packetized digital data streams is presented. The synchronization apparatus includes a telemetry synchronization (SYNC) word generator, wherein the SYNC word generator produces a sequential series of SYNC words, and wherein the respective SYNC words consist of successions of symbols, a first packetized digital data stream, wherein data timing of the first stream is associated with timing of the SYNC word generator, a data packet capture function configured to capture packets in a second stream of digital data packets, a SYNC embedment function, wherein captured digital data packets are modified by substitution of symbols from SYNC words for portions of data contained within the captured packets, and a digital packet transmission function for the first and modified second data packet streams.

In another aspect, a method for establishing synchronization between packetized, digitized audio/video signals and packetized telemetry is presented. The synchronization method includes generating a succession of digitized time values, capturing a succession of Ethernet audio/video (AV) signal data packets, wherein data items representing a succession of values of digitized AV signals are contained within the Ethernet AV packets, embedding the succession of time values into the succession of AV signal value data items, wherein a subset of the digital content of successive digitized audio data values is replaced by a subset of a digitized time value, and retransmitting Ethernet AV data packets wherein digitized audio data values include embedded time value subsets.

In yet another aspect, an Ethernet-compatible apparatus for synchronization of first and second packetized digital data streams is presented. The apparatus includes a telemetry synchronization (SYNC) word generator configured to provide a succession of SYNC words, wherein the respective SYNC words consist of successions of symbols. The apparatus further includes a data item acquisition function, wherein the data items represent a succession of values of digitized audio/video (AV) signals, and wherein digitized audio data items are a subset of the AV data items. The apparatus further includes an embedment function for embedding the succession of SYNC words into the succession of digitized audio data items, wherein symbols within the digital content of successive digitized audio data values are replaced by successive symbols from digitized time values, and a transmitter for Ethernet AV data packets, wherein a digitized audio data value subset of the Ethernet AV data packets includes embedded time value symbols.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. It is also to be understood that the phraseology and terminology employed herein, as well as the abstract, are for the purpose of description, and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a sensor amplifier configured for use in medical applications in accordance with the present invention.

FIG. 2 is a block diagram of a sensor amplifier in accordance with FIG. 1.

FIG. 3 is a block diagram of a filter in accordance with the invention.

FIG. 4 is a waveform diagram of an analog function corresponding to the function of the digital filter of the invention.

FIG. 5 is a system block diagram for a system that transfers video/audio camera signals synchronized with physiological telemetry.

FIG. 6 is a packet signal timing diagram illustrating placement of synchronization bits in an Ethernet audio/video telemetry stream.

### DETAILED DESCRIPTION

The invention will now be described with reference to the drawing figures, in which like reference numerals refer to like parts throughout. An embodiment in accordance with the present invention provides self-contained multi-channel amplifiers and filters for medical applications, separate headboxes—that is, passive interface units having input ports mechanically and electrically compatible with medical sensor leads, and having output ports configured to connect directly or by signal cables to amplifier/filter units' input ports—one or more video input ports, signal processing facilities for formatting and/or structuring the data acquired by the amplifier/filter channels and the video channels, and bidirectional communication linkage to remote units via Ethernet communications protocols.

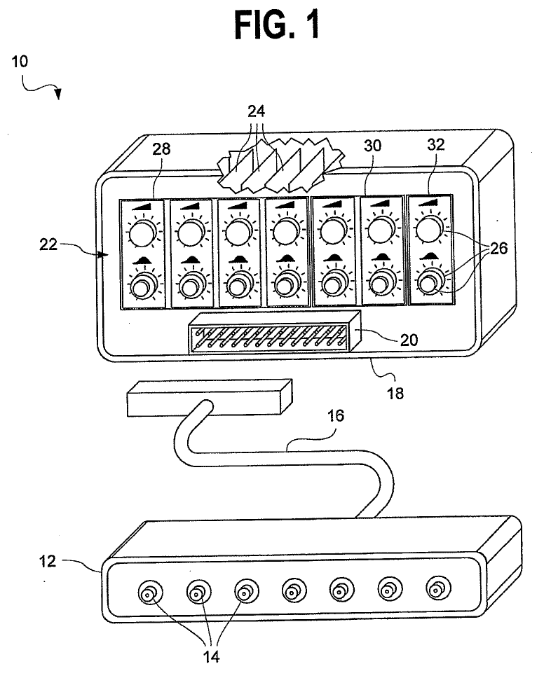

FIG. 1 shows an amplifier/filter 10 according to an embodiment of the invention. The amplifier/filter 10 includes a headbox 12, a term understood in the art to include a passive module having a plurality of input connectors 14 in a suitable configuration to support attachment of art-standard devices such as physiological sensor leads (not shown), and to provide a standard and/or consolidated output such as a connectorized cable 16. A representative headbox 12 is passive, that is, has connectors and wires but no active electronics, and exhibits little effect on signals detected by the sensor leads beyond minimal attenuation from distributed impedances.

The amplifier/filter 10 further includes an operational chassis enclosure 18 that includes a mating connector 20 for the cable 16 from the headbox 12. In the embodiment shown, the enclosure 18 includes a user interface 22 having a plurality of separate controllers 24 (located within the box) for the channels brought from the headbox 12 input connectors 14. It is to be understood that in other embodiments, the number of parameters per channel to be controlled may be so great—e.g., input impedance, DC coupling, filter low and high corners and/or rolloff, saturation recovery, analog and/or digital gain, converter sample rate, and the like—as to render infeasible the use of separate controls per parameter, as is represented by knobs 26 in FIG. 1. In such embodiments, physical presentation may include an on-amplifier keypad- or touchscreen-based user interface for parameter selection and modification, a port whereby the amplifier/filter 10 may be controlled from an external device such as a personal computer, access for configuration control via an Ethernet link to a remote location, another type of interface, or a combination of interfaces that may further be hierarchical, that is, one interface may be empowered to lock out or override another. Tradeoffs between direct visibility of configuration and enablement of highly flexible and remotely controllable configuration are known in the art, and are presented as novel herein only as noted.

Channels in a first group 28 in the embodiment shown may be dedicated to single-ended operation, that is, have a single input signal line referred to amplifier ground. Channels in a second group 30 may support both single-ended and differential operation—that is, include amplifiers that accept signal pairs isolated from signal ground within the amplifier/filter 10 (amplifier ground), and may selectively provide one or two ground-referred single-ended outputs or a single-ended output referred to the differential between the floating input lines. Channels in a third group 32—in the embodiment shown, there is one such channel—may likewise accept differential signals, but further enable direct current (DC) coupling in support of certain types of DC-referred signal transducers.

The channels 28, 30, and 32 may be configurable with high-pass and low-pass filters. Because the invention was developed with reference to medical measurements, with particular emphasis on electronic sensing of physiological phenomena related to electroencephalography (EEG), polysomnography (sleep studies), epilepsy, long-term maintenance (LTM), and other processes, many of which involve relatively low-frequency, low-amplitude sensor signals, low-pass filters for at least some embodiments can be configured to permit selection of rolloff at frequencies such as 250 Hz, as well as various lower frequencies, potentially down to a fraction of one hertz in some embodiments. The high-pass filters, switchable as noted on any DC-capable channels 32, and selectable in all channels in the embodiment shown, may block signals below 1 Hz, 0.053 Hz (roughly 20 seconds period) or other useful lower limits. Since such filters may saturate, and may recover slowly in human terms, the filters may be configurable to support accelerated recovery in response to a manual command to reset, such as from a maximum (instantaneous) output to zero output.

Individual channel and/or all-channel gain may be selectable in some embodiments. Control over gain and both corner frequencies, as well as rolloff rate where applicable, may be accessed through software in at least some embodiments, permitting setup and operation to be preprogrammed or actively controlled from a location remote from that of the amplifier. Autoranging for gain or filter parameters may be desirable in some embodiments, either autonomously within each amplifier channel or using feedback either within the amplifier or from the remote (host) device that uses the collected data.

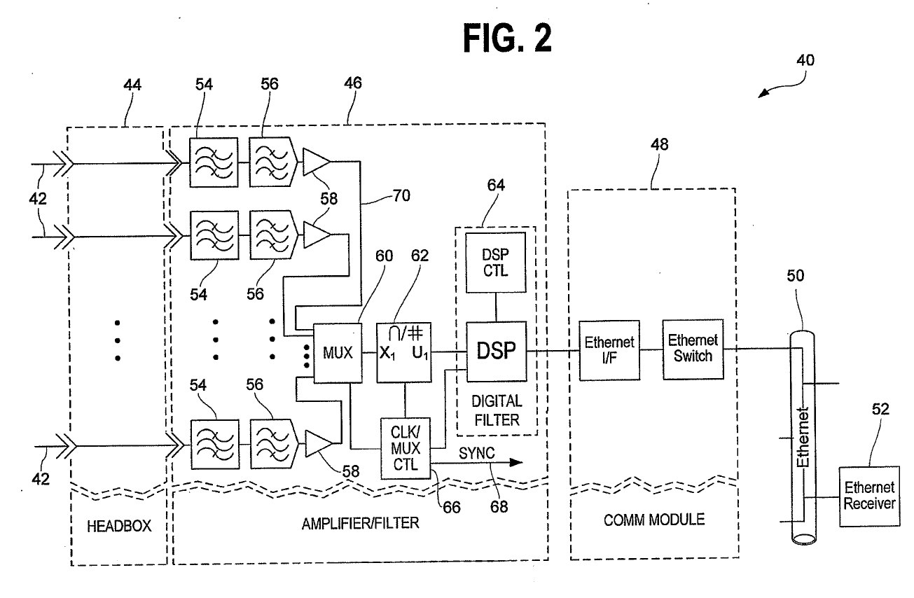

FIG. 2 is a functional block diagram 40 detailing aspects of the amplifier/filter of FIG. 1. The diagram 40 shows a plurality of input channels 42 and associated segments of a headbox 44, wherein the headbox 44 outputs are connected to an amplifier/filter 46 that supports the plurality of input channels 42, a communication module 48 configured for data flow through an Ethernet interconnection system 50, and a single receiver 52 to which data flows via the Ethernet connection 50.

The amplifier input channels 42 may include passive isolation networks (analog front ends) 54, incorporating switchable and/or nonswitchable filter elements (not shown) that may be insertable into the circuit manually or by software-based control signals in some embodiments. The passive analog front ends 54 may be followed by active analog front ends 56 having more switchable impedance units (not shown). Such arrangements can limit risk of saturation and aliasing by applying isolation and at least a portion of the filtering function before amplification (first gain section) 58, multiplexing 60, analog-to-digital (A/D) conversion 62 and digital filtering 64. The corollary to this is the necessity for the isolation networks 54 to have robust and low-noise components, while the signal applied to the first gain section 58 is quite low in maximum amplitude, requiring high gain and stability along with gain circuit 58 designs that realize low noise through component choice and circuit configuration.

Following the analog front end 54, 56, 58, a multiplexer (MUX) 60 sequentially applies the channels 42 to an A/D converter 62. A clock 66-driven synchronization signal 68 allows the channels 42 to be converted from analog 70, with all channels 42 synchronous within a time skew established by the clock 66. In some embodiments, all channels 42 may be captured virtually exactly synchronously using sample-and-hold circuitry per channel (not shown) ahead of the MUX 60, while in other embodiments, the successive samples may be skewed relative to one another according to the MUX 60 transfer rate, which corresponds generally to the arrangement shown in the block diagram 40. Yet another arrangement may be preferred in other embodiments, provided the arrangement selected realizes a raw digital signal 72 wherein each channel 42 is digitized with a selected sample rate and precision, and the sample times for all channels 42 are known relative to an initialization event.

Digitization and data capture may use any of a variety of methods, including but not limited to sample-and-hold followed by ramp or successive approximation, delta-sigma conversion with or without sample-and-hold, and other methods known or to be developed. Similarly, hardware complexity may be controlled by methods such as multiplexing 60 all channels 42 into a single, relatively high-performance A/D converter 62, as shown, multiplexing 60 each few channels 42 into one of several slower A/D converters 62, then consolidating the multiple channels of digital data using digital data management techniques (not shown), or assigning a dedicated A/D converter 62 for each channel 42, with no analog MUXs 60, and with all data consolidation managed in the digital domain (not shown).

In each of these and other arrangements, sample skew may be managed separately from conversion strategy, in view of considerations such as power draw-induced noise. For example, use of a large number of slow, low-power A/D converters 62, all clocked to convert simultaneously, may cause power distribution transients that can introduce appreciable voltage errors in exchange for minimizing synchronization errors. The same A/D converters 62, clocked in sequence, may produce significantly less voltage error but have a pronounced skew across channels. Similar tradeoffs may be understood to apply for substantially all techniques and configurations. For applications such as physiological measurements, it may be noted that errors associated with channel-to-channel skew may be small enough to be unimportant provided the sample rate is, for example, well in excess of the Nyquist rate. It may be further noted that the extent of correlation from channel to channel may itself be low for at least some applications, and thus a minor consideration. It is further to be understood that skew errors may be substantially correctable by computational methods where the channel-to-channel delay is well defined.

In all such embodiments, the converted data may be stored at least once as an intermediate process. Where multiplexing is employed, the converted data may be managed in multiplexed form, such as by rendering the overall processing substantially synchronous, so that each datum is used or reused at predetermined intervals, or by associating an identifier with each datum, so that each process is performed in accordance with instructions attached to the data. In other embodiments, data may be distributed to storage locations associated with the input channels, such as by using the addressing that controls the multiplexer, with processing performed on discrete address blocks. Tradeoffs between intermediate data management strategies affect at least physical size, interconnection complexity, programming complexity, and end-to-end processing speed of data manipulating devices. Such tradeoffs are well known in the art, and are not addressed herein further than to identify a general strategy and to observe that a range of solutions can provide similar, albeit unequal, outcomes.

A digital filter 64 is applied to the A/D converted signal 72 in the embodiment shown in FIG. 2. The filtered signal 74 is then combined 76 with other data 78 and formatted 80 for local storage 82 or transmission 84.

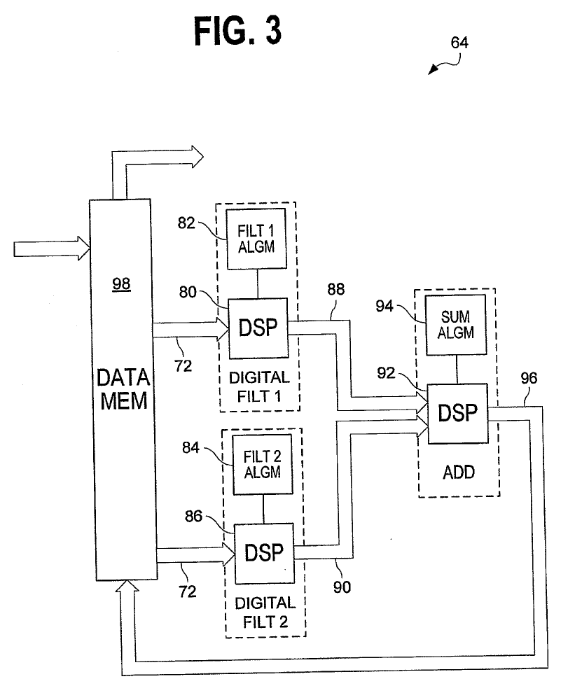

FIG. 3 shows the core filter function 64 of FIG. 2 in greater detail. A first digital signal processing (DSP) device 80 employed in the embodiment shown filters the raw digitized analog sensor data 72.

Known methods of DSP 80 coding—that is, software-based algorithms executed in computation-oriented digital electronic devices, along with related data management procedures—for filtering of low-amplitude, low-frequency sensor signals use Chebychev, Butterworth, Sallen-Key, Bessel, Cauer, state-variable, or like algorithms to provide filtering in a single function, with a knee location and an extent of rolloff (i.e., number and placement of poles) selected according to established methods. Such processes apply particular algorithms to sequences of data values, using data management methods such as rolling averages, sliding windows, and the like to process physiological measurements or other data captured and digitized at successive points in time.

In some filter embodiments, A/D converter 62 output 72 word length is finite and comparatively short, and fixed-point numbers rather than floating point are produced. Data processing speed in such embodiments may be rapid, permitting, for example, a single DSP 80 to perform all processing for a multichannel filter/amplifier. However, processing accuracy—and thus introduction of noise through processing—can be highly dependent on algorithm selection.

In some digital filters for fixed-point numbers, a given time sample may recur in a finite number of processing steps, and may be scaled to a different amplitude in each, for example. In other such filters, a calculation residue may be added back indefinitely, further attenuated each time, so that a sample that contributes to that residue gradually loses its importance compared to newer data elements. Effects of these and other filtering processes are well understood in the digital filtering art; error artifacts can include degradation of signal quality as a function of quantization noise—roundoff, finite word length, and the like—through multiple mathematical processes.

It has been demonstrated that the summation (with inversion and scaling as required) of at least two digital all-pass filter functions, each of which may be distinct in filter parameters, can realize a desired extent of band filtering—that is, high-pass, low-pass, or band-pass—while decreasing introduction of quantization noise into the signal so processed when compared to known methods of digital band filtering.

In the present invention, digitized, fixed-point data 72 is applied as digital filter 64 input, where a first DSP 80 executes a first digital all-pass filter algorithm. The first DSP 80 introduces a first spectrally profiled phase shift to the signal. The first digital all-pass filter algorithm is stored in a first filter-control element 82 and executed by the first DSP 80. This first all-pass filter algorithm applies phase shift to some spectral components of the digitized input signal 72 to the first DSP 80 that differs from phase shift applied to other spectral components of the same digitized input signal 72, while the relative magnitude of the spectral components may be substantially unaffected.

A second digital all-pass filter algorithm is similarly stored in a second filter-control element 84 and executed by the second DSP 86. Similarly to the first algorithm and DSP 80, the second DSP 86 introduces a second spectrally profiled phase shift to the input signal 72. Once again, the relative magnitude of the spectral components may be substantially unaffected.

A first digitized, all-pass-filtered intermediate signal 88 output from the first DSP 80 and a second digitized, all-pass-filtered intermediate signal 90 output from the second DSP 86 are then applied as inputs to a third DSP 92 that executes a summing algorithm 94 to yield an output signal 96. The digital signal stream 96, effectively bandpass-filtered, can then be passed through the system, such as by formatting the signal 96 as telemetry, by transmitting, storing, and recovering the signal 96 from a telemetry stream, by converting the signal 96 back to analog, by displaying the signal 96 as a voltage waveform, and the like.

Note that, as in band filters, all-pass digital filters may process successive data samples repeatedly in order to realize particular filter characteristics, storing intermediate values between processing steps, scaling and combining samples such as by shifting and adding, and the like. Because a plurality of all-pass filter algorithms exists, it is to be understood that selection of a digital all-pass algorithm may bear on several criteria, such as processor bandwidth, intermediate element storage resources, availability and cost of licenses for particular hardware or software, and the like.

It is to be understood that the DSP functions represented in FIG. 3 as functional blocks in a diagram are subject to realization in a plurality of embodiments. Such embodiments include at least software sequences stored in and executed from processor-readable memory, dedicated hardware in the form of specialized data handling circuitry, and logic processes loaded into gate array circuits preparatory to execution, as well as other known and future realizations.

The term digital signal processor is applied herein with reference to any of the above as well as to other technological realizations that permit rapid and repeated processing of digital data constructs, without preference for the approach selected for an embodiment. Similarly, references to algorithms that control the DSP are intended herein to refer at least to any control sequence for a general-purpose processor, dedicated DSP microcircuit, or like embodiment, or for a logic-based functional arrangement programmed into a programmable gate array microcircuit or like embodiment, wherein the control sequence or functional arrangement realizes at least a portion of a filter of the type described.

It is to be understood that a DSP may be realized as a processor that reads and executes software sequences stored in a machine-readable storage device. Such a device may be a self-contained general purpose computer that includes one or more microprocessors, memory devices, input-output features such as user interfaces and communication elements, power converters, and the like. Such a processor may instead be a general-purpose computing module such as a microprocessor-based circuit board enclosed within and interfacing to a specialized apparatus such as a multichannel amplifier. Such a processor may also be a general-purpose computing device embedded within a specialized apparatus such as a multichannel amplifier, supported by memory and interface components likewise embedded within the specialized apparatus.

The specific type of processor known in the art as a digital signal processor (DSP) may be an integrated circuit component with register architecture, instruction set, data handling capability, and other attributes more nearly optimized for repetitive data element manipulation than is a processor known in the art as a general-purpose computer. While a DSP is commonly configured as a component embedded within a specialized circuit board, and supported by co-located control, memory, interface, and other functional devices, other embodiments are realizable.

Equivalent functionality may be realized in still other embodiments, such as devices known in the art as field-programmable gate arrays (FPGAs), mask-programmable gate arrays, and custom and semi-custom integrated circuit components. FPGAs (the related types indicated herein are included within this acronym for brevity) may include so-called intellectual property (IP) embedded within the programmed device. Such IP, which term implies development by an entity that may be other than an end-product developer, may include the realization of a known microprocessor or DSP type, for example, in the form of a set of instructions to configure the interconnection of the gates within the FPGA to emulate the throughput and timing of that microprocessor or DSP when programmed with instructions compatible therewith. Memory, data handling, and other custom or IP functions may be embedded within one or more FPGA devices along with one or more microprocessors or DSPs, for example. Thus, the operations described herein may be performed in a variety of physical realizations.

It is further to be understood that the IP and associated functionality within an FPGA has physical realization at least during operation. That is, programming a group of gates within the FPGA causes the gates to be interconnected to perform a specific function, in a fashion electrically equivalent to the interconnection performed during fabrication of a non-programmable integrated circuit (IC), for example, so that the electrical properties of the FPGA during use may be indistinguishable from those of the IC. While some FPGA-class devices may support being configured only once, and must be deinstalled and replaced by other physical devices in order to modify operation of a product wherein the FPGAs are installed, other FPGAs are reprogrammable, so that product functionality may be revised, including dynamically in response to data flow or user input, for example.

The number of physical DSP devices 80, 86, 92 used may be selected according to such considerations as throughput requirements. In the embodiment shown, for clarity, three individual DSP devices are presented, each executing either a single all-pass filter algorithm function or an add function. In other embodiments, one DSP may be used, with the intermediate data stored in memory 98 as needed between successive operations that use different processes or filter parameters. In still other embodiments, multiple data channels may be processed by a single DSP or a triple-DSP data path similar to that shown. In yet other embodiments, three or more DSP devices may each perform all-pass filtering on a single data stream, followed by a summation process, or the same data may be processed four or more times by a single DSP with intermediate storage, or the like, in embodiments wherein a process using three or more digital all-pass filter steps is defined and is preferred. In each such embodiment, the inventive core function includes processing a digitized signal by a plurality of digital all-pass filters, followed by combining the results, with the digital output signal characterized by a preferred extent of filtering and a reduced extent of degradation of fixed-point content by quantization than in known high-, low-, or band-pass digital filters.

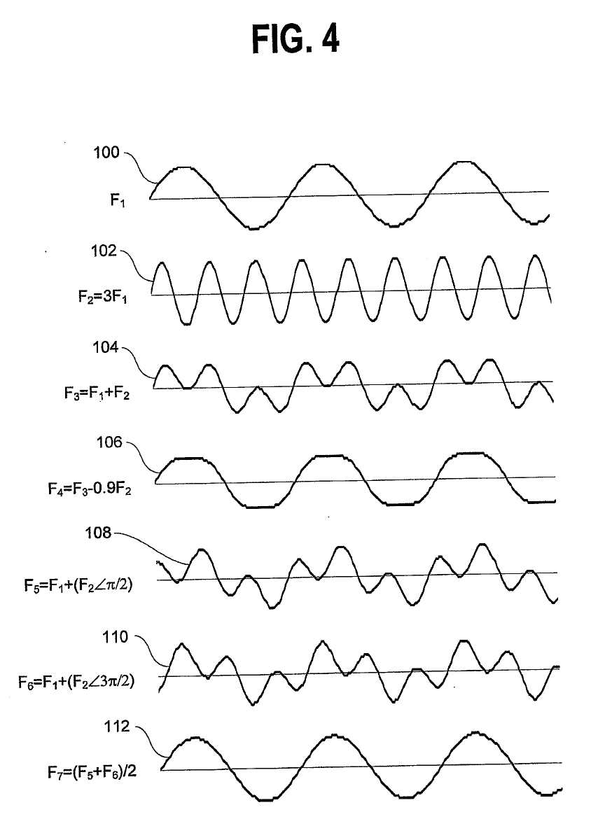

FIG. 4 presents a basic analogy to the inventive process, in the analog time domain, using a desired sine wave 100 upon which an undesired third harmonic 102 is superimposed (in phase, and at equal magnitude, in this example) to form a composite signal 104. A conventional analog low-pass filter may remove a substantial portion of the unwanted third harmonic 102, at significant cost in material complexity due to the proximity of wanted and unwanted components, while providing an imperfect realization 106. In contrast, the original composite signal can be passed through two all-pass filters, changing the relative phase of the components of the composite signal 104, providing a first all-pass output 108 and a second all-pass output 110. If these signals are then summed (assuming no clipping or degradation due to component noise), the shifted second harmonic signals may be canceled 112, arguably with a higher degree of accuracy in proportion to equipment cost than if a single low-pass filter is used. Analog-domain apparatus for realizing the waveforms shown in FIG. 4 may have a block diagram representation that somewhat resembles the digital-domain apparatus of FIG. 3, with operational amplifier-based filters and summers implementing the processing in lieu of data storage elements, DSP elements, software storage elements, and the like.

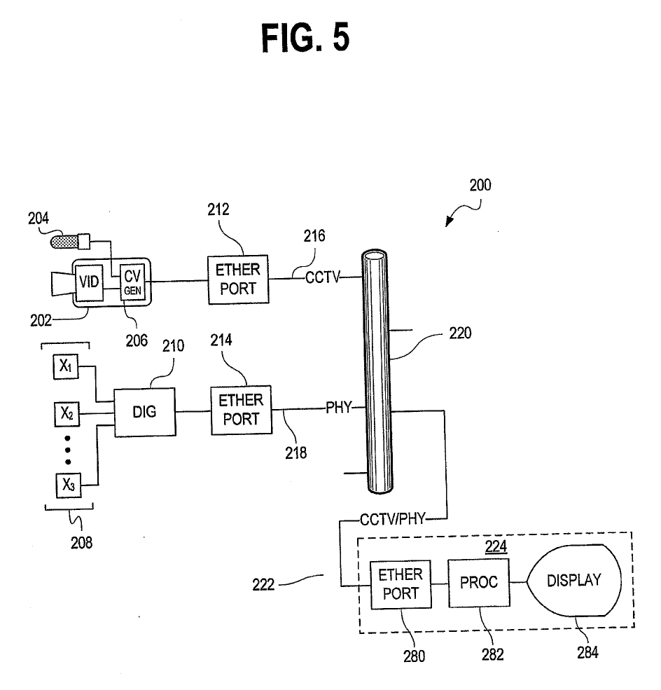

FIG. 5 is a block diagram 200 showing a video camera 202 with an associated audio pickup 204 and composite video generator 206, a set of analog physiological transducers 208 connected to a digitizer 210, Ethernet converters 212, 214 for the respective video/audio (historically referred to as closed-circuit television, or CCTV) and physiological (PHY) data streams 216, 218, an Ethernet switch 220, and a link signal path 222 to a remote display 224. In known practice, the separate (CCTV and PHY) streams are not intrinsically synchronized, or indeed directly associated, so that correlation of images and sounds to measurements retains uncertainty. For example, despite respective crystal oscillators, use of separate timebases in a CCTV system and a PHY stream generator may result in drift of several seconds over a period of hours, so that physical observations cannot be reliably correlated to telemetry events. Where the Ethernet switch 220 accepts the two packet streams and routes them to separate destination addresses within a remote display 224, realtime observation may permit an analyst to infer correlation, but recording and reviewing the information streams relies on resources such as time tags in an archive, which may be uncertain.

The present invention overcomes CCTV/PHY synchronization uncertainty by embedding time-related data directly associated with the PHY information into particular data locations within the CCTV transmission. As a consequence, a PHY data block can be correlated to CCTV visual and sound events within timing parameters selected by a developer or, if so enabled by user-accessible configuration controls, a user.

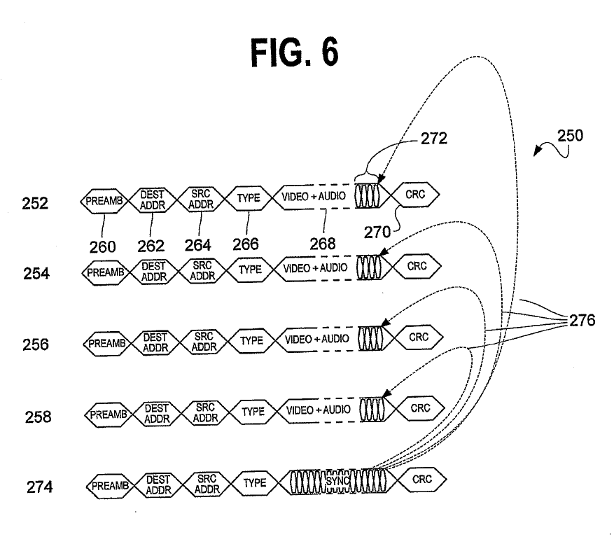

FIG. 6 is a packet diagram 250 wherein representative digital CCTV audio data words 252, 254, 256, and 258, including associated packet steering information, i.e., Ethernet addressing, are shown. Assuming ordinary Ethernet packet structure (IEEE 802.3 is similar), a preamble 260 of some 64 bits, a destination address 262 of 48 bits, a source address 264 of 48 bits, a type field 266 of 16 bits, a variable-length data field 268, and a cyclic redundancy check (CRC) field 270 of 32 bits make up each packet. The audio data words 272 in the representation are two bytes (sixteen bits, fixed point) of the data field 268; in practice, the sixteen-bit length provides a level of resolution that may be in excess of the resolution of the remainder of the audio signal path, which is limited by transducer precision, A/D and D/A converter resolution and filtering, and sample rate. At least the least significant bit (LSB) of each respective audio data sample has been shown by experiment to be redundant in some embodiments, so that, for example, if the LSB of each successive word is fixed at zero or one, or replaced by a random number, for example, no readily-detectable change in audio performance may be evident. Where audio is digitized with lower resolution, such as twelve bits, where more than the indicated two bytes is allowed for transmission, where reconstructed performance may not be as demanding, where floating point is used, and in other embodiments, any effect of fixing or randomizing the LSB may be even less detectable than indicated.

FIG. 6 further shows a PHY synchronization word (SYNC word) 274. This word is generated, preferably within the amplifier, as a time reference, is distributed to the PHY and control channels of the amplifier, and is transmitted by Ethernet protocol to a remote user 224, shown in FIG. 5. The SYNC word 274 may be, for example, an integer count of sample clocks, omitting some number of LSBs. In embodiments that use the MUX 32 shown in FIG. 2 or a related configuration, the timing function may include a count value, functioning as an address, in addition to clock and data enable signals needed to initiate and/or process conversions. The count value/addresses can be applied to the MUX 32, selecting each analog channel 22 in turn and directing its signal to the ADC 34 input. A representative address for a 32-channel amplifier, for example, can be implemented using five count value/address lines. A counter using five low-order bits as address lines can use higher-order lines to form a count value representing the number of all-channel samples performed since initialization/reset or counter rollover, for example.

A count value (i.e., a SYNC word) may be included in the non-video-related telemetry stream as one of every n system samples, where a system sample is a sample of an analog line applied to the amplifier or an item of amplifier status information; for the embodiments indicated herein, the rate at which count values are included in the telemetry stream may be further associated with the audio sample rate. For example, if a single camera has one microphone channel limited to 5 KHz, necessitating an audio sample rate of about 10 KHz, and if one bit of a 32-bit count value is transmitted with each audio sample, as elaborated below, then a count value need be extracted no more frequently than each 3.2 msec, or about 31.25 count values per second, to occupy all available LSB locations.

If the 32 channels of a physiologic amplifier embodiment are all bandwidth limited at 1 KHz, in continuation of the example, then the MUX 32 must scan through all channels at a 2 KHz rate, advancing by 64 000 counts per second. This permits roughly one SYNC word for each 2 000 counts to be sent. Thus if five LSBs of the counter are applied as addresses to the MUX 32, then these five LSBs and six more are left out of the transmitted SYNC word, and synchronization precision is nominally about a millisecond, which is acceptable for at least some physiological applications. Similar computations apply for other sample rate limits and synchronization requirements. General stability of the circuits and software involved in synchronizing the video and telemetry streams may reduce uncertainty further, while residual jitter may be observed in response to time correction events.

SYNC word length may be further considered as a design tradeoff. A minimum SYNC word length may be that length which is sufficient to assure count rollover after no less than 24 hours in at least some embodiments; in others, more bits may be required to provide unique results over a desired period. The foregoing embodiment realizes a count that rolls over after somewhat more than four years.

The PHY and control channels in the embodiment shown may incorporate a SYNC word into the data streams they create, periodically including the SYNC word in addition to telemetry elements in the generated data stream. It is to be understood that the digitization process for a multichannel amplifier generates significantly fewer data packets than the maximum that a 100 megabit Ethernet path (100 base T), for example, can transfer, even in conjunction with a digital CCTV baseband signal. It is to be further understood that a word length and a word generation interval for a SYNC word are preferably to be selected in view of criteria such as duration of data acquisition activity, frequency stability of data acquisition apparatus, extrinsic requirements such as privacy or uniqueness of a time indication, and the like.

The embedment of the PHY synchronization word 274 into the amplifier telemetry stream is intrinsic to the purpose-developed operation of a physiologic amplifier as described herein. However, the CCTV used with the amplifier may not be unique to the system of FIG. 5. As a consequence, it may be preferable to retain an effectively unchanged CCTV output data stream in some embodiments, while in other embodiments it may be preferable to insert synchronization between the CCTV and PHY functions prior to final formation of the CCTV output data stream.

Because the audio data within Ethernet CCTV baseband packets have characteristic timing and identification, it may be feasible in some embodiments to identify, acquire, and modify them, such as by assigning to the LSB of each audio word 272 a successive bit 276 of the PHY SYNC word 274. Since Ethernet packets in the transport layer may employ a transmission control protocol (TCP), for example, and may arrive in an uncertain order, it may be preferable to identify the audio data packets with reference to the order in which they were generated, with each successive SYNC word bit 276 inserted into an audio data packet in that order. As indicated above, this has been shown to leave reconstructed audio undegraded for the intended purposes of physiologic amplifiers.

In other embodiments, audio data packets may be available for synchronization at the application level, that is, with little or no embedded overhead, such as with audio data words stored in a memory area, momentarily held within a formatting device, or the like. In these embodiments, bit substitution may be performable with minimal impact on timing, formatting, data integrity, and the like.

The above discussion identifies particular audio data word lengths and characteristics of particular formats of SYNC information. More generally, digitized audio data may be generated with any user-selected sampling interval and word length, and SYNC words may likewise be generated at any desired rate and have any desired word length. In order to preserve adequate fidelity in audio content, and to transmit SYNC words that are sufficiently close to unique to permit reconstruction of timing, audio at a selected sampling rate, with a selected number of audio channels, using a selected encoding strategy, may be formatted for transmission in combination with one or more bits from available SYNC words, limited by fidelity and uniqueness considerations. The SYNC word length may be subject to user preference, and the number of audio data bits subject to replacement may likewise vary.

The term “symbol” is introduced herein to indicate a portion of a sync word, of a size selected by the user and suited to the application. As noted above, the symbol may be a single bit, used to replace an audio data word LSB. In another embodiment, a 12-bit A/D converter may be used for audio word generation, although audio data is transferred in 16-bit blocks. In such an embodiment, the four least-significant bits may all be filler, and it may be preferred to embed a four-bit SYNC symbol, or to combine SYNC data and other data, such as configuration notes, apparatus serial numbers, or the like, in the audio. In still other embodiments, coder/decoder (CODEC) or multiple-channel audio may further influence audio data format, with SYNC symbol size and placement modified to accommodate system needs.

Reversal of the PHY synchronization word embedment process shown in FIG. 4 is substantially symmetrical in some embodiments. The remote display 224 of FIG. 5 includes, in addition to an Ethernet port 280, a message processor 282 that can include a capture algorithm to differentiate between video/audio packets transported on the CCTV path 216 and data packets transported on the PHY path 218, such as by source or destination address. Such an algorithm can further extract the LSBs of audio packets in order, and reconstruct the PHY SYNC word. The reconstructed PHY SYNC word can uniquely identify a time relationship between events encoded in the CCTV and PHY data, and allow a user to affirm correlation between display and telemetry and to present the data streams with an accurate time relationship.

Other issues, including privacy, may bear consideration in the context of the present invention. While raw CCTV and PHY data may be generated, marked for synchronization, transferred, displayed, and stored, any of these processes may be compromised to the extent of allowing unqualified individuals to view, acquire, or alter information, such as in contravention of laws such as the Health Insurance Portability and Accountability Act (HIPAA). While much of the safeguarding required under law is beyond the scope of this invention, it is to be understood that further control of sensitive information may be realized by cryptologic processes readily introduced in the course of providing the synchronization described herein. As a minimal security provision, for example, successive synchronization bits may be inverted n times, where n is the bit position modulo two within the sync word. Similarly, the synchronization bits may be embedded according to a rule other than LSB placement, such as with the remaining bits of the audio data shifted, so that the audio content is recoverably distorted but the synchronization word is unrecoverable without access to the bit placement algorithm. For another example, the order of data packets of the CCTV and PHY data may be altered according to an encryption algorithm, reassigning addresses so that mere extraction of packet content does not provide identifiable video, audio, and/or PHY data. Further, information in individual packets may be encrypted, so that the content is not identifiable without access to the encryption rules.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. An Ethernet-compatible apparatus for synchronization of first and second packetized digital data streams, comprising:
a telemetry synchronization (SYNC) word generator, wherein the SYNC word generator produces a sequential series of SYNC words, and wherein the respective SYNC words consist of successions of symbols;
a first packetized digital data stream, wherein data timing of the first stream is associated with timing of the SYNC word generator;
a data packet capture function configured to capture packets in a second stream of digital data packets;
a SYNC embedment function, wherein captured digital data packets are modified by substitution of symbols from SYNC words for portions of data contained within the captured packets; and
a digital packet transmission function for the first and modified second data packet streams.

2. The synchronization apparatus of claim 1, wherein the first packetized, transmitted digital data stream comprises at least in part successive SYNC words created by the SYNC word generator, wherein successive SYNC words correspond to successive time values and are nonrepeating over a selected interval.

3. The synchronization apparatus of claim 1, wherein each symbol consists of a single bit.

4. The synchronization apparatus of claim 3, wherein the symbols are embedded in least-significant-bit locations within sequential second-stream digital data packets.

5. The synchronization apparatus of claim 1, wherein each symbol consists of a plurality of bits.

6. The synchronization apparatus of claim 5, wherein the symbols are embedded within second-stream digital data packets in locations comprising a plurality of least-significant-bits not less than the number of bits of the symbol.

7. The synchronization apparatus of claim 1, wherein the symbols are embedded within second-stream digital data packets by displacing higher-order bits to other bit locations within the packets and inserting the symbols at least in part in bit locations wherefrom the higher-order bits are displaced.

8. The synchronization apparatus of claim 1, wherein the digital packet transmission function for the first and modified second data packet streams directs the streams to separate receiving addresses.

9. The synchronization apparatus of claim 1, further comprising:
a first telemetry receiving function for the first data packet stream;
a second telemetry receiving function for the modified second data packet stream;
a first extraction function, configured to extract SYNC words from the first data packet stream, further configured to distribute data from remaining first-stream packets into at least one first presentation stream;
a second extraction synchronization function, configured to extract SYNC words from modified packets within the second data packet stream, further configured to distribute data from remaining second-stream packets into at least one second presentation stream;
a synchronization function, configured to adjust presentation timing to establish simultaneous presentation of the first and second streams within a selected time offset range.

10. A method for establishing synchronization between packetized, digitized audio/video signals and packetized telemetry, comprising:
generating a succession of digitized time values;
capturing a succession of Ethernet audio/video (AV) signal data packets, wherein data items representing a succession of values of digitized AV signals are contained within the Ethernet AV packets;
embedding the succession of time values into the succession of AV signal value data items, wherein a subset of the digital content of successive digitized audio data values is replaced by a subset of a digitized time value; and
retransmitting Ethernet AV data packets wherein digitized audio data values include embedded time value subsets.

11. The method for establishing synchronization of claim 10, wherein the acquired time values are nonrepeating over a predetermined interval, are synchronized to a succession of data acquisition values, and are digitized and packetized as telemetry.

12. The method for establishing synchronization of claim 10, further comprising capturing a succession of data acquisition elements, wherein the AV signal values correlate chronologically with the data acquisition elements within predetermined embedment timing parameters.

13. The method for establishing synchronization of claim 12, further comprising:
forming a succession of Ethernet telemetry packets, wherein each packet contains at least a valid destination address and at least one of an acquired data element or a plurality of subsets of a time value that correlates chronologically with the data acquisition element within predetermined embedment timing parameters; and
transmitting the Ethernet telemetry packets.

14. The method for establishing synchronization of claim 10, wherein successive Ethernet AV packets comprise at least valid destination addresses and successive audio signal data values.

15. The method for establishing synchronization of claim 10, further comprising replacing least-significant bits in successive digitized audio signal values by successive bits of a time value that correlates chronologically with the successive audio signal values within predetermined embedment timing parameters.

16. The method for establishing synchronization of claim 13, further comprising:
receiving the AV and telemetry Ethernet packets;
stripping out the audio data from the AV packets;
extracting the digitized time value subsets from the audio data; and
reconstructing the time values from the subsets extracted from the audio data.

17. The method for establishing synchronization of claim 16, further comprising:
stripping out the time values from the telemetry packets; and
reconstructing the time values from the time value symbols extracted from the telemetry packets.

18. The method for establishing synchronization of claim 17, further comprising:
forming presentation streams from the respective AV and telemetry packets;
adjusting presentation stream timing so that AV and telemetry have time values synchronized within predetermined embedment timing parameters; and
presenting the AV and telemetry streams.

19. A method for establishing synchronization between packetized, digitized audio/video signals and packetized telemetry, comprising:
generating a succession of digitized time values, nonrepeating over a predetermined interval, synchronized to a succession of digitized data acquisition values, wherein each time value comprises a plurality of symbols;
accessing a succession of digitized audio/video data values, wherein chronological occurrence and sequencing of the audio/video data values correlate to chronological occurrence and sequencing of the data acquisition values within selected embedment timing parameters;
embedding successive symbols from a time value into successive digitized audio/video data values, wherein a subset of the content of successive digitized audio data elements is replaced by successive time value symbols;
forming a succession of Ethernet audio/video data packets comprising successive audio data elements wherein successive symbols from the time value are embedded;
forming a succession of Ethernet telemetry packets, wherein each telemetry packet comprises at least one datum, and wherein the at least one datum is a data acquisition element or a plurality of symbols of a time value associated with the data element; and
transmitting the Ethernet packets.

20. An Ethernet-compatible apparatus for synchronization of first and second packetized digital data streams, comprising:
means for generating a succession of telemetry synchronization (SYNC) words, wherein the respective SYNC words consist of successions of symbols;
means for acquiring data items representing a succession of values of digitized audio/video (AV) signals, wherein digitized audio data items are a subset of the AV data items;
means for embedding the succession of SYNC words into the succession of digitized audio data items, wherein symbols within the digital content of successive digitized audio data values are replaced by successive symbols from digitized time values; and
means for transmitting Ethernet AV data packets wherein a digitized audio data value subset thereof includes embedded time value symbols.

21. The synchronization apparatus of claim 20, further comprising:
means for generating time values that are nonrepeating over a predetermined interval;
means for acquiring data values including at least the time values, wherein the data values are distinct from the AV signals, wherein the data values are digitized and packetized as Ethernet telemetry; and
means for transmitting the data values.

22. The synchronization apparatus of claim 20, further comprising:
means for receiving the AV and telemetry Ethernet packet streams;
means for stripping out the audio data from the AV packets;
means for extracting the digitized time value symbols from the audio data;
means for reconstructing the time values from the symbols extracted from the audio data;
means for stripping out the time values from the telemetry packets; and
means for synchronizing presentation of AV and telemetry from the reconstructed time values from the respective Ethernet packet streams.
